(19) United States
(12) Patent Application Publication
(10) Pub. No.: US 2022/0045708 A1
(43) Pub. Date: Feb. 10, 2022

(54) MOBILE PHONE RING HOLDER

(71) Applicant: SHENZHEN MAIKUO TRADING CO., LTD., SHENZHEN (CN)

(72) Inventor: YUANQING YOU, QIANDONGNAN MIAO AND DONG (CN)

(21) Appl. No.: 17/506,708

(22) Filed: Oct. 21, 2021

(51) Int. Cl. H04B 1/3888

(52) U.S. Cl. CPC H04B 1/3888

(57) ABSTRACT

The present invention relates to the field of mobile phone holders, and particularly involves a mobile phone ring holder. When a mobile phone needs to be charged wirelessly, a shell can be removed, an insulating substrate can be left on the mobile phone side, and the insulating substrate will not hinder the wireless charging. After the charging is completed, the shell can be installed again. The thickness of the insulating substrate is made to be 0.8 mm, so that the mobile phone with a magnetic attraction charging function can be subjected to magnetic attraction charging for use, and the use of function of a vehicle-mounted magnetic attraction holder is supported by means of a magnetic attraction sheet.

### TECHNICAL FIELD

The present invention relates to the field of mobile phone holders, and particularly involves a mobile phone ring holder.

### BACKGROUND ART

A ring holder is usually mounted on the back of a mobile phone to support the mobile phone and allow a user to hold the mobile phone firmly, which actually brings great convenience to the user.

With the development of wireless charging technology, more and more mobile phones have adopted wireless charging at present. However, a ring holder is mounted on the back of the mobile phone and has a large thickness, which seriously hinders wireless charging and cannot support wireless charging, resulting in bringing inconvenience to users. Therefore, it is necessary to improve existing ring holders.

### SUMMARY OF THE INVENTION

In order to solve the above problems, the present invention provides a mobile phone ring holder. As an insulating substrate is detachable from a shell, and a rotary seat is provided with a magnetic attraction sheet, the problem that existing ring holders cannot support wireless charging can be effectively solved.

In order to achieve the above objective, the present invention adopts the following technical solution: a mobile phone ring holder comprises an insulating substrate, an adhesive pad, a shell, a rotary seat and a ring, wherein the shell is detachably snap-fitted on the front surface of the insulating substrate and covers the insulating substrate; the adhesive pad is fixed to the back surface of the insulating substrate; the rotary seat is rotatably mounted on the front surface of the shell, and the ring is mounted on the rotary seat in a back-and-forth flipping manner; both sides of the insulating substrate are provided with clamping blocks, and both sides of the back surface of the shell are provided with clamping grooves corresponding to the clamping blocks, wherein the insulating substrate is slidably inserted into corresponding clamping grooves by means of the clamping blocks, and can be detachably connected to the shell.

At least two positioning blocks are also convexly provided on the front surface of the insulating substrate, positioning grooves corresponding to the positioning blocks are provided on the back surface of the shell, the insulating substrate is slidably inserted into corresponding clamping grooves by means of the clamping blocks, and the positioning blocks are equipped in the positioning grooves.

Further, the surface of the shell is provided with a rotary seat assembling groove, a clamping column component perpendicular to the body of the shell is integrally formed on the rotary seat assembling groove, an assembling hole is formed in the center of the rotary seat, the clamping column component is inserted into the assembling hole, and the rotary seat can freely rotate 360 degrees around the clamping column component.

Further, the surface of the rotary seat assembling groove is evenly provided with a plurality of first concave points in a circle, the bottom surface of the rotary seat is also evenly provided with a plurality of second convex points in a circle, and the second convex points are clamped to the first concave points to achieve positioning.

Further, both sides of the bottom surface of the rotary seat are provided with rotary shaft assembling grooves, and rotary shafts located on both sides of the ring are equipped in the rotary shaft assembling grooves, respectively, and are hinged with the rotary seat of the ring to realize an inversion of 90 degrees.

Further, the clamping column component comprises three elastic sub clamping columns arranged in a circumferential direction of the clamping column component, a clamping hook is integrally formed at a top end of each of the elastic sub clamping columns, an inner wall of the assembling hole is convexly provided with a circle of limit boss, and when the elastic sub clamping columns penetrate through the assembling hole, the clamping hooks on the elastic sub clamping columns will be clamped on the limit boss.

Further, the surface of the rotary seat is provided with a magnetic attraction sheet, and the surface of the magnetic attraction sheet is provided with CD-grain aluminum alloy.

Further, the surface of the rotary seat assembling groove is further convexly provided with a ring positioning block, and inner walls on both sides of the ring are tightly attached to an outer side wall of the ring positioning block.

Further, the end, away from the rotary shafts, of the ring is provided with a lifting gap.

Further, the thickness of the insulating substrate is 0.8 mm.

The present invention has the following beneficial effects:

1. Both sides of the insulating substrate are provided with clamping blocks, and both sides of the back surface of the shell are provided with clamping grooves corresponding to the clamping blocks, wherein the insulating substrate is slidably inserted into corresponding clamping grooves by means of the clamping blocks, and can be detachably connected to the shell; when the mobile phone needs to be charged wirelessly, the shell can be removed, the insulating substrate can be left on the mobile phone side, and the insulating substrate will not hinder the wireless charging, and after the charging is completed, the shell can be installed again and is then magnetically attracted to a corresponding position by means of the magnetic attraction sheet, which brings convenience to users.

2. In addition, in the present application, disposing a magnetic attraction sheet on the surface of the rotary seat may support the use of function of a vehicle-mounted magnetic attraction holder, which is more convenient and efficient.

3. For a mobile phone with a magnetic attraction charging function, the thickness of the insulating substrate is made to be 0.8 mm, so that the mobile phone with the magnetic attraction charging function can be subjected to magnetic attraction charging for use.

4. With the widespread use of automobile magnetic attraction holders, the usability of the product is expanded, so that the product can be used on vehicle-mounted magnetic attraction holders.

### BRIEF DESCRIPTION OF THE DRAWINGS

FIG. 1 is a schematic structural diagram of the mobile phone ring holder.

FIG. 2 is a schematic structural diagram of the insulating substrate.

FIG. 3 is a schematic structural diagram of the shell.

FIG. 4 is a schematic structural diagram of the assembled rotary seat and ring.

FIG. 5 is a rear view of the assembled rotary seat and ring.

FIG. 6 is a schematic structural diagram of further assembly of the magnetic attraction sheet on the basis of FIG. 4.

Reference numerals are as follows: insulating substrate 1, clamping block 11, positioning block 12, shell 2, rotary seat assembling groove 21, first concave point 22, elastic sub clamping column 23, clamping hook 231, ring positioning block 24, rotary seat 3, assembling hole 31, limit boss 311, second convex point 32, rotary shaft assembling groove 33, ring 4, rotary shaft 41, lifting gap 42, magnetic suction sheet 5, and CD-grain alloy 6.

### DETAILED DESCRIPTION OF EMBODIMENTS

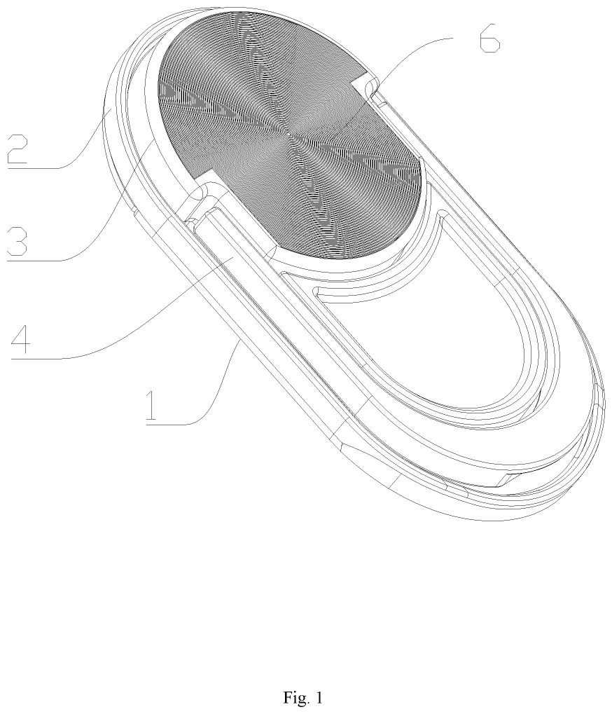

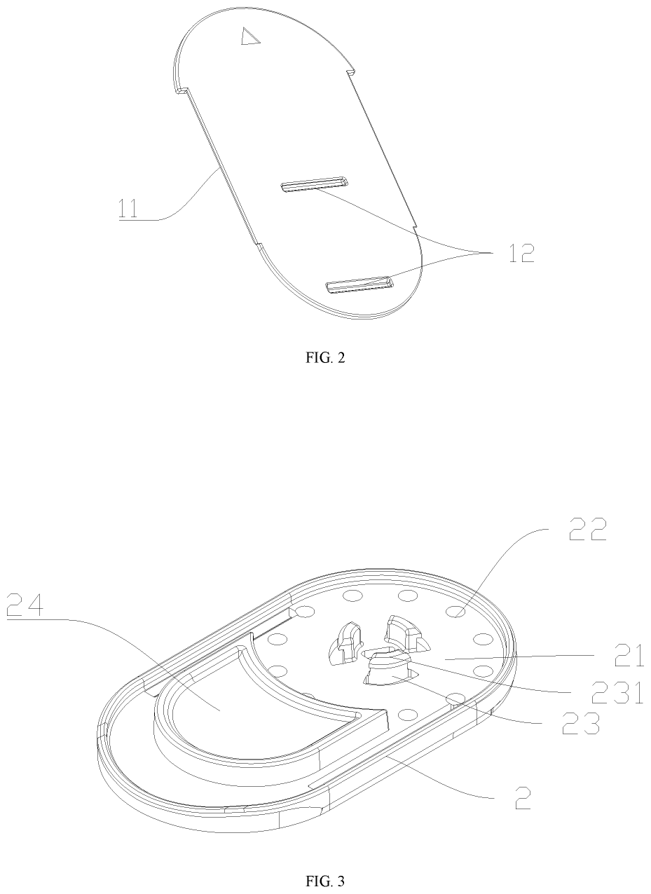

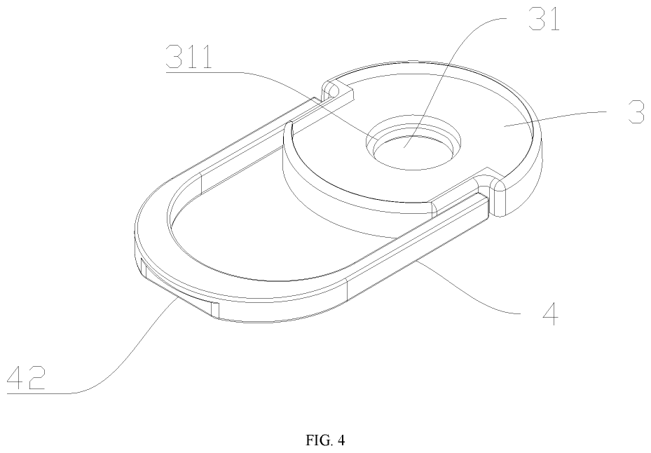

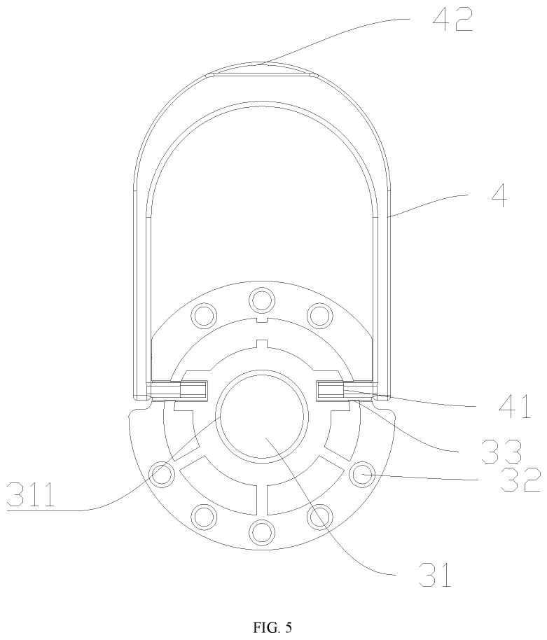

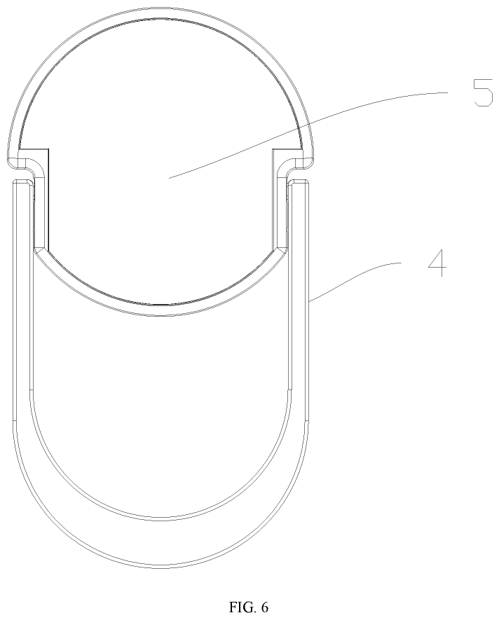

Referring to FIGS. 1-6, the present invention involves a mobile phone ring holder, comprising an insulating substrate 1, an adhesive pad, a shell 2, a rotary seat 3 and a ring 4, wherein the shell 2 is detachably snap-fitted on the front surface of the insulating substrate 1 and covers the insulating substrate 1; the adhesive pad is fixed on the back surface of the insulating substrate 1; the rotary seat 3 is rotatably mounted on the front surface of the shell 2, and the ring 4 is mounted on the rotary seat 3 in a back-and-forth flipping manner; both sides of the insulating substrate 1 are provided with clamping blocks 11, and both sides of the back surface of the shell 2 are provided with clamping grooves corresponding to the clamping blocks 11, wherein the insulating substrate 1 is slidably inserted into corresponding clamping grooves by means of the clamping blocks 11, and can be detachably connected to the shell 2;

At least two positioning blocks 12 are also convexly disposed on the front surface of the insulating substrate 1, positioning grooves corresponding to the positioning blocks 12 are formed on the back surface of the shell 2, the insulating substrate 1 is slidably inserted into corresponding clamping grooves by means of the clamping blocks 11, and the positioning blocks 12 are equipped in the positioning grooves.

Both sides of the insulating substrate 1 are provided with clamping blocks 11, and both sides of the back surface of the shell 2 are provided with clamping grooves corresponding to the clamping blocks 11, wherein the insulating substrate 1 is slidably inserted into corresponding clamping grooves by means of the clamping blocks 11, and can be detachably connected to the shell 2; when the mobile phone needs to be charged wirelessly, the shell 2 can be removed, the insulating substrate 1 can be left on the mobile phone side, and the insulating substrate 1 will not hinder the wireless charging, and after the charging is completed, the shell 2 can be installed again, so that the product can support wireless charging, and convenience is brought to users. In addition, in the present application, disposing a magnetic attraction sheet 5 on the surface of the rotary seat 3 can support the use of function of a vehicle-mounted magnetic attraction holder, which is more convenient and efficient.

For a mobile phone with a magnetic attraction charging function, the thickness of the insulating substrate is made to be 0.8 mm, so that the mobile phone with the magnetic attraction charging function can be subjected to magnetic attraction charging for use. With the widespread use of automobile magnetic attraction holders, the usability of the product is expanded, so that the product can be used on vehicle-mounted magnetic attraction holders.

Further, the surface of the shell 2 is provided with a rotary seat assembling groove 21, a clamping column component perpendicular to the body of the shell 2 is integrally formed on the rotary seat assembling groove 21, an assembling hole 31 is formed in the center of the rotary seat 3, the clamping column component is inserted into the assembling hole 31, and the rotary seat 3 can rotate freely around the clamping column component. Thus, in the present application, the whole ring 4 and the shell 2 are in a detachable state, and the ring 4 can be replaced at any time once damaged, which brings quite convenient mounting and dismounting.

Further, the surface of the rotary seat assembling groove 21 is evenly provided with a plurality of first concave points 22 in a circle, and the bottom face of the rotary seat 3 is also evenly provided with a plurality of second convex points 32 in a circle, wherein the second convex points 32 are clamped to the first concave points 22 to achieve positioning. In other words, when a user pulls the ring 4 and makes the rotary seat 3 rotate around the clamping column component to an appropriate position, the second convex points 32 can be clamped to the first concave points 22 to achieve primary positioning, and the ring 4 will not be thrown casually; meanwhile, an included angle between the ring 4 and the rotary seat 3 can be changed to make the ring 4 play a holder role in supporting the mobile phone. Moreover, the cooperation between the second convex points 32 and the first concave points 22 can also make the rotary seat 3 accurately placed in an assembling groove of the ring 4, so that even when not in use, the rotary seat 3 can be prevented from rotating relative to the clamping column component.

Further, both sides of the bottom surface of the rotary seat 3 are provided with rotary shaft assembling grooves 33, wherein rotary shafts 41 located on both sides of the ring 4 are equipped in the rotary shaft assembling grooves 33, respectively, and can be hinged with the rotary seat 3.

Further, the clamping column component comprises three elastic sub clamping columns 23 arranged in a circumferential direction of the clamping column component, wherein a clamping hook 231 is integrally formed at a top end of each of the elastic sub clamping columns 23, an inner wall of the assembling hole 31 is convexly provided with a circle of limit boss 311, and when the elastic sub clamping columns 23 penetrate through the assembling hole 31, the clamping hooks 231 on the elastic sub clamping columns 23 will be clamped on the limit boss 311. Since in the present application, the elastic sub clamping columns 23 are elastic, when the rotary seat 3 is damaged and needs to be replaced, the user can push the clamping hooks 231 to the middle to make the clamping hooks 231 separated from the limit boss 311, and then take out the whole rotary seat 3.

Further, the surface of the magnetic attraction sheet 5 is provided with CD-grain aluminum alloy 6. The provided CD-grain aluminum alloy 6 can effectively avoid leaving fingerprints to keep the appearance thereof clean.

Preferably, in order to prevent the ring 4 from being misaligned when not working, further, the surface of the rotary seat assembling groove 21 is further convexly provided with a ring positioning block 24, wherein inner walls on both sides of the ring 4 are tightly attached to an outer side wall of the ring positioning block 24, and the ring positioning block 24 plays a role in limiting.

Preferably, since the ring 4 is attached to the ring positioning block 24 by default, in order to facilitate lifting the ring 4, the end, away from the rotary shafts 41, of the ring 4 in the present application is provided with a lifting gap 42.

The above embodiments merely describe preferred embodiments of the present invention and do not limit the scope of the present invention. Various modifications and improvements made to the technical solutions of the present invention by those of ordinary skill in the art without departing from the spirit of the present invention shall fall within the scope of protection defined by the claims of the present invention.

1. A mobile phone ring holder, comprising an insulating substrate, an adhesive pad, a shell, a rotary seat and a ring, wherein the shell is detachably snap-fitted on the front surface of the insulating substrate and covers the insulating substrate; the adhesive pad is fixed to the back surface of the insulating substrate; the rotary seat is rotatably mounted on the front surface of the shell, the ring is mounted on the rotary seat in a back-and-forth flipping manner, and the surface of the rotary seat is provided with a magnetic attraction sheet; both sides of the insulating substrate are provided with clamping blocks, and both sides of the back surface of the shell are provided with clamping grooves corresponding to the clamping blocks, wherein the insulating substrate is slidably inserted into corresponding clamping grooves by means of the clamping blocks, and can be detachably connected to the shell;
At least two positioning blocks are also convexly provided on the front surface of the insulating substrate, positioning grooves corresponding to the positioning blocks are provided on the back surface of the shell, the insulating substrate is slidably inserted into corresponding clamping grooves by means of the clamping blocks, and the positioning blocks are equipped in the positioning grooves.

2. The mobile phone ring holder according to claim 1, wherein the surface of the shell is provided with a rotary seat assembling groove, a clamping column component perpendicular to the body of the shell is integrally formed on the rotary seat assembling groove, an assembling hole is formed in the center of the rotary seat, the clamping column component is inserted into the assembling hole, and the rotary seat can rotate 360 degrees around the clamping column component.

3. The mobile phone ring holder according to claim 2, wherein the surface of the rotary seat assembling groove is evenly provided with a plurality of first concave points in a circle, the bottom surface of the rotary seat is also evenly provided with a plurality of second convex points in a circle, and the second convex points are clamped to the first concave points to achieve positioning.

4. The mobile phone ring holder according to claim 3, wherein both sides of the bottom surface of the rotary seat are provided with rotary shaft assembling grooves, and rotary shafts located on both sides of the ring are equipped in the rotary shaft assembling grooves, respectively, and can be hinged with the rotary seat.

5. The mobile phone ring holder according to claim 4, wherein the clamping column component comprises three elastic sub clamping columns arranged in a circumferential direction of the clamping column component, a clamping hook is integrally formed at a top end of each of the elastic sub clamping columns, an inner wall of the assembling hole is convexly provided with a circle of limit boss, and when the elastic sub clamping columns penetrate through the assembling hole, the clamping hooks on the elastic sub clamping columns will be clamped on the limit boss.

6. The mobile phone ring holder according to claim 1, wherein the surface of the rotary seat is provided with a magnetic attraction sheet, and the surface of the magnetic attraction sheet is provided with CD-grain aluminum alloy.

7. The mobile phone ring holder according to claim 2, wherein the surface of the rotary seat assembling groove is further convexly provided with a ring positioning block, and inner walls on both sides of the ring are tightly attached to an outer side wall of the ring positioning block.

8. The mobile phone ring holder according to claim 7, wherein the end, away from the rotary shafts, of the ring is provided with a lifting gap.

9. The mobile phone ring holder according to claim 1, wherein the thickness of the insulating substrate is 0.8 mm.
